(19) United States
(12) Patent Application Publication
(10) Pub. No.: US 2022/0148550 A1
(43) Pub. Date: May 12, 2022

(54) MICRO-PERFORATED PANEL SYSTEMS, APPLICATIONS, AND METHODS OF MAKING MICRO-PERFORATED PANEL SYSTEMS

(71) Applicant: CORNING INCORPORATED, CORNING, NY (US)

(72) Inventors: Prashanth Abraham Vanniamparambil, Ellicott, MD (US); Mark Owen Weller, Painted Post, NY (US)

(21) Appl. No.: 17/432,545

(22) PCT Filed: Mar. 4, 2020
(86) PCT No.: PCT/US2020/020861

§ 371 Date: Aug. 20, 2021

Related U.S. Application Data
(60) Provisional application No. 62/813,745, filed on Mar. 4, 2019.

(51) Int. Cl. G10K 11/162; E06B 5/20

(52) U.S. Cl. CPC G10K 11/162; C03C 21/002; E06B 5/20

(57) ABSTRACT

The described embodiments relate generally to a micro-perforated panel systems, methods for noise abatement, methods of meeting safe breaking requirements and methods of making micro-perforated panel systems. In particular, embodiments relate to glass micro-perforated panel systems for noise abatement and meeting safe breaking requirements.

### CROSS-REFERENCE TO RELATED APPLICATIONS

This application claims the benefit of priority under 35 U.S.C. § 119 of U.S. Provisional Application No. 62/813,745, filed Mar. 4, 2019, the content of which is incorporated herein by reference in its entirety.

### BACKGROUND

### Field

The described embodiments relate generally to a micro-perforated panel systems, methods for noise abatement, methods of meeting safe breaking requirements and methods of making micro-perforated panel systems. In particular, embodiments relate to glass micro-perforated panel systems for noise abatement and meeting safe breaking requirements.

### Technical Background

Glass is a highly desirable architectural product owing to its superior optical attributes, scratch and corrosion resistance, durability, waterproof, aesthetic quality, fire resistance, etc. For example, unlike polymeric materials such as polycarbonate, glass does not “yellow” over time, has high strength and scratch resistance, and may be cleaned using UV methods. However, the high density and acoustic impedance of glass leads to high acoustic reflections (e.g., echo), poor speech intelligibility, and a low noise reduction coefficient (NRC) which limits its widespread use in architectural applications particularly. Ordinary glass has nearly no sound absorption coefficient (NRC about 0.05) leading to undesirably long reverberation time and poor acoustic environment when used.

Establishing optimal room acoustics has been a growing need for many interior architectural applications including, for example, open office workspace, hospitals, classrooms, airports, automotive applications, and more. Not only can continuous exposure to sound levels greater than 85 decibels (dB) lead to hearing loss, but even noise at much lower level can be a significant distraction and lead to reduced productivity, reduced ability to concentrate or rest, and in general make a room acoustically unpleasant. Current approaches for sound absorbing include the use of acoustic foam, fibrous materials, and other non-transparent, non-glass materials.

It is desirable that glass used in architectural applications break safely upon various types of impact. For example, it is important that the glass or glass ceramic not break into large sharp shards upon impact. Specifically, it is desirable that the glass meet safe breaking requirements outlined in ANSI Z97.1, including that upon testing, e.g. hole punch impact testing, the total of the 10 largest crack-free pieces weighs no more than the weight of 10 square inches of the original test sample and no one piece is longer than 4 inches with minor exceptions.

A technical solution is required to improve acoustic properties, including NRC rating, and safe breaking properties of glass to be used in various operative environments where noise control and safe breaking is desirable.

### SUMMARY

According to an embodiment of the present technology, an article comprises a glass or glass ceramic panel having a plurality of micro-perforations positioned at non-uniform intervals along the panel wherein the panel has regions of close spacing between micro-perforations and regions of broad spacing between micro-perforations.

For example, the regions of close spacing can have a distance between micro-perforations of between about 0.25 mm and about 5 mm, or between about 1 mm and about 2 mm.

For example, the regions of broad spacing can have a distance between micro-perforations of between about 0.5 mm and about 6 mm, or between about 2 mm and about 4 mm.

For example, the ratio of the distance between micro-perforations in the regions of broad spacing to the distance between micro-perforations in the regions of close spacing is between about 1.3 and about 12, or between about 1.8 and about 4.

In some embodiments, the thickness is between about 0.5 mm and about 4 mm, or between about 0.7 mm and about 1.2 mm.

In some embodiments, the panel can comprise a strengthened glass or glass ceramic, e.g., mechanically, thermally or chemically strengthened.

In some embodiments, the panel can have a Noise Reduction Coefficient (NRC) of between about 0.3 and 1, or between about 0.3 and about 0.8.

In some embodiments the panel has a predetermined sound absorption coefficient over a predetermined frequency band between 250 Hz and 6000 Hz, or between 250 Hz and 20,000 Hz.

In some embodiments, the panel breaks upon hole punch impact to produce crack-free pieces and wherein the weight of the ten largest crack-free pieces is less than or equal to the weight of 10 square inches of the original panel.

In some embodiments, the micro-perforations are distributed with non-uniform density along the panel.

In some embodiments, an opening of a plurality of the micro-perforations are non-circular.

In some embodiments, the porosity of micro-perforations is in the range of about 0.05% to 10%.

In some embodiments, the diameter of each of the plurality of micro-perforations is between about 20 um and about 700 um, or between about 200 um and about 500 um.

In another embodiment of the technology, an article comprise first and second glass or glass ceramic panels each having a plurality of micro-perforations positioned at non-uniform intervals along the panel wherein the panels each have regions of close spacing between micro-perforations and regions of broad spacing between micro-perforations.

In some embodiments, the first and second panels are spaced from each other by an intra-panel gap that defines a separation distance.

In some embodiments, the first and second panels are generally parallel to each other.

In some embodiments, the article is thermally strengthened.

In some embodiments, the first and second panels are positioned such that there is no solid back wall within 1 m of the first and second panels that is generally parallel to the first panel or the second panel.

In some embodiments, the first and second panels are positioned such that there is a solid back wall within 1 m of the first and second panels that is generally parallel to the first panel or the second panel.

In some embodiments, the NRC of the article is 0.4 or greater.

In some embodiments, the porosity of micro-perforations in each of the first and second glass or glass ceramic panels is in the range of about 0.05% to about 10%.

In some embodiments, the diameter of each of the plurality of micro-perforations is in the range of about 50 um to about 700 um, or about 200 um to about 500 um.

In another embodiment of the present technology, a method of forming micro-perforations in a glass or glass ceramic panel comprises forming a plurality of damage tracks into the glass or glass ceramic panel by a laser beam, wherein the damage tracks are positioned at non-uniform intervals with regions of close spacing between damage tracks and regions of broad spacing between damage tracks; and etching the panel obtained from (i) in an acid solution to form a micro-perforated panel with micro-perforations at non-uniform intervals along the panel having regions of close spacing between micro-perforations and regions of broad spacing between micro-perforations, wherein the NRC of the micro-perforated panel is between about 0.3 and 1 and the glass or ceramic panel meets ANSI Z97.1 breaking requirements.

In some embodiments, the laser beam is a pulsed laser beam having a focal line oriented along a beam propagation direction and directing the laser beam focal line into the panel.

In some embodiments the method also involves etching the glass panel in a second acid solution that is different from the first acid solution.

In some embodiments, the method also involves chemically or thermally strengthening the micro-perforated panel.

In some embodiments, the glass or glass ceramic panel comprises a high-strength glass or glass ceramic composition.

In some embodiments, the thickness of the glass or glass ceramic panel is between about 0.5 mm and about 4 mm, or about 0.7 mm and about 1.2 mm.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1A shows an article according to an embodiment.

FIG. 1B shows a close-up view of micro-perforations in the article shown in FIG. 1A.

FIG. 2A shows a shows a partial close up view of micro-perforations according to an embodiment

FIG. 2B shows a cross sectional view of micro-perforations according to an embodiment.

FIG. 3 shows articles according to an embodiment after hole punch impact testing.

FIG. 4 shows representative sound absorption coefficient across various frequencies of a micro-perforated panel according to an embodiment.

FIG. 5A shows a comparative bare glass breaking pattern.

FIG. 5B shows a comparative breaking pattern for a glass panel with uniform spacing between micro-perforations.

FIG. 6A shows cross sectional retardation measurements using polariscope for uneven micro-perforations according to an embodiment.

FIG. 6B shows cross sectional retardation measurements using polariscope for even micro-perforations according to an embodiment.

FIG. 7 shows potential micro-perforation non-circular shapes according to embodiments.

FIG. 8A shows a comparative breaking pattern for a glass panel with uniform spacing between micro-perforations.

FIG. 8B shows a breaking pattern according to an embodiment.

FIG. 8C shows a comparative breaking pattern for a glass panel with uniform spacing between micro-perforations.

### DETAILED DESCRIPTION

In the following detailed description, numerous specific details may be set forth in order to provide a thorough understanding of embodiments of the invention. However, it will be clear to one skilled in the art when embodiments of the invention may be practiced without some or all of these specific details. In other instances, well-known features or processes may not be described in detail so as not to unnecessarily obscure the invention. Moreover, unless otherwise defined, all technical and scientific terms used herein have the same meaning as commonly understood by one of ordinary skill in the art to which this invention belongs. In case of conflict, the present specification, including the definitions herein, will control.

Although other methods and can be used in the practice or testing of the invention, certain suitable methods and materials are described herein.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. As used herein, “approximately” or “about” may be taken to mean within 10% of the recited value, inclusive.

The term “or”, as used herein, is inclusive; more specifically, the phrase “A or B” means “A, B, or both A and B.” Exclusive “or” is designated herein by terms such as “either A or B” and “one of A or B,” for example.

The indefinite articles “a” and “an” are employed to describe elements and components of the invention. The use of these articles means that one or at least one of these elements or components is present. Although these articles are conventionally employed to signify that the modified noun is a singular noun, as used herein the articles “a” and “an” also include the plural, unless otherwise stated in specific instances. Similarly, the definite article “the”, as used herein, also signifies that the modified noun may be singular or plural, again unless otherwise stated in specific instances.

As used herein, ranges are inclusive of the end points, and “from,” “between,” “to,” “and,” as well as other associated language includes the end points of the ranges.

As used herein, the term “micro-perforations” may include circular and/or non-circular shaped micro-holes. The term “non-circular” may include any arbitrary shape that is not circular. The term “diameter” may be taken to mean the minimum distance across an opening of the micro-perforation at a point through the centroid of the micro-perforation, where the centroid and diameter are based on the area of the micro-perforation on a surface of the panel in which the micro-perforation is present. For example, when the micro-perforations are substantially circularly cylindrical, the diameter is the distance across the center of the circle defining the opening.

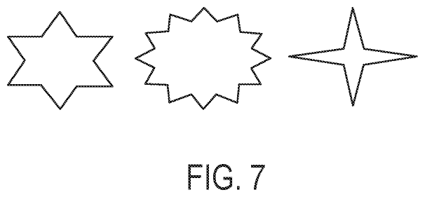

Additionally, as shown in FIG. 7, the openings of the micro-perforations may be non-circular such that the micro-perforation is not circularly cylindrical. In these cases, the “diameter” may be taken to mean the minimum distance across the non-circular opening of the micro-perforation that crosses through the centroid. The terms “hole” and “micro-perforation” are used interchangeably.

Addressing room acoustics is challenging as it involves both architectural design and engineering in addition to acoustic science and principles. Micro-perforated panels in general may form a resonant sound absorbing system, based on the Helmholtz resonance principle.

There can be safety concerns with architectural uses of glass or glass ceramic materials. For example, the glass or glass ceramic panels may break into large shards if damaged. As such, glass and glass ceramic materials for use in architecture must meet the ANSI Z97.1 standard for safe breaking. The present disclosure offers glass and glass ceramic panels that have acoustic benefits while also having features that allow them to break safely and meet the ANSI Z97.1 breaking standard, e.g. for use in architectural applications.

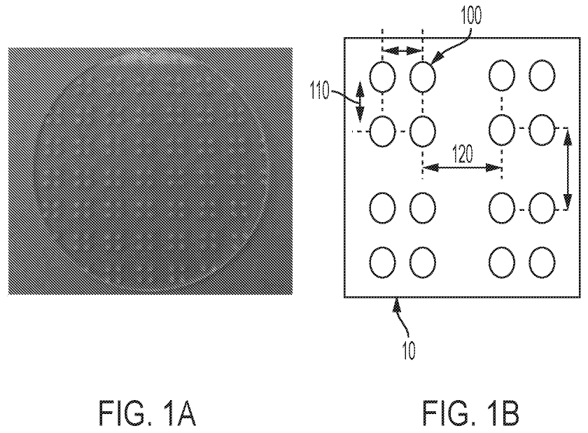

As shown in FIGS. 1A-B, for example, some embodiments of the present disclosure are directed to an article, including: a glass or glass ceramic panel 10 having a plurality of micro-perforations 100 positioned at non-uniform intervals along the panel wherein the panel has regions of close spacing between micro-perforations 110 and regions of broad spacing between micro-perforations 120. The spacing of the micro-perforations is known as pitch and the present disclosure deals with “mixed pitch” having non-uniform spacing between micro-perforations.

As shown in FIG. 1B, the regions of close spacing have a distance between micro-perforations 130 that can be measured by the distance between the centroid of one micro-perforation to the centroid of the next micro-perforation. In some embodiments, the regions of close spacing have a distance between micro-perforations of between about 0.25 mm and about 1 mm, about 0.25 mm and about 2 mm, about 0.25 mm and about 3 mm, about 0.25 mm and about 4 mm, about 0.25 and about 5 mm, about 0.5 mm and about 1 mm, about 0.5 mm and about 2 mm, about 0.5 mm and about 3 mm, about 0.5 mm and about 4 mm, about 0.5 mm and about 5 mm, about 1 mm and about 2 mm, about 1 mm and about 3 mm, about 1 mm and about 4 mm, about 1 mm and about 5 mm, about 2 mm and about 4 mm, about 2 mm and about 5 mm, about 3 mm and about 4 mm, about 3 mm and about 5, about 4 mm and about 5 mm. In some embodiments, the regions of close spacing have a distance between micro-perforations of about 0.25 mm, 0.5 mm, 1.0 mm, 1.5 mm, 2.5 mm, 3.0 mm, 3.5 mm, 4.0 mm, 4.5 mm, 5.0 mm or any range having any two of these values as endpoints. In some embodiments, the regions of close spacing have a distance between micro-perforations of about 0.25 mm and about 5 mm, or between about 1 mm and about 2 mm. In one embodiment, the regions of close spacing have a distance between micro-perforations of about 1.5 mm.

As shown in FIG. 1B, the regions of broad spacing have a distance between micro-perforations 140 that can be measured by the distance between the centroid of one micro-perforation to the centroid of the next micro-perforation. In some embodiments, the regions of broad spacing have a distance between micro-perforations of between about 0.5 mm and about 1 mm, about 0.5 mm and about 2 mm, about 0.5 mm and about 3 mm, about 0.5 mm and about 4 mm, about 0.5 and about 5 mm, about 0.5 mm and about 6 mm, about 1 mm and about 2 mm, about 1 mm and about 3 mm, about 1 mm and about 4 mm, about 1 mm and about 5 mm, about 1 and about 6 mm, about 2 mm and about 4 mm, about 2 mm and about 5 mm, about 2 and about 6 mm, about 3 mm and about 4 mm, about 3 mm and about 5, about 3 mm and about 6 mm, about 4 mm and about 5 mm, about 4 mm and about 6 mm, about 5 and about 6 mm. In some embodiments, the regions of close spacing have a distance between micro-perforations of about 0.5 mm, 1.0 mm, 1.5 mm, 2.5 mm, 3.0 mm, 3.5 mm, 4.0 mm, 4.5 mm, 5.0 mm, 5.5 mm, 6.0 mm or any range having any two of these values as endpoints. In some embodiments, the regions of close spacing have a distance between micro-perforations of about 0.5 mm and about 6 mm, or between about 2 mm and about 4 mm. In one embodiment, the regions of broad spacing have a distance between micro-perforations of about 3.0 mm.

In some embodiments, the ratio of the distance between micro-perforations in the regions of broad spacing to the distance between micro-perforations in the regions of close spacing is between about 1.3 to about 12, about 1.5 to about 12, about 2 to about 12, about 4 to about 12, about 6 to about 12, about 8 to about 12, about 10 to about 12, about 1.3 to about 10, about 1.5 to about 10, about 2 to about 10, about 4 to about 10, about 6 to about 10, about 8 to about 10, about 1.3 to about 8, about 1.5 to about 8, about 2 to about 8, about 4 to about 8, about 6 to about 8, about 1.3 to about 6, about 1.5 to about 6, about 2 to about 6, about 4 to about 6, about 1.3 to about 4, about 1.5 to about 4, about 2 to about 4, about 1.3 to about 2, about 1.5 to about 2 or about 1.3, 1.4, 1.5, 1.6, 1.7, 1.8, 1.9, 2, 2.1, 2.2, 2.3, 2.4, 2.5, 3.0, 3.5, 4, 4.5, 5, 5.5, 6, 6.5, 7, 7.5, 8, 8.5, 9, 9.5, 10, 10.5, 11, 11.5, 12, 13, 14, 15, 16, 17, 18, 19, 20, 22, 23, 24 or any range having any two of these values as endpoints. In some embodiments, the distance between micro-perforations in the regions of broad spacing to the distance between micro-perforations in the regions of close spacing is between about 1.3 and about 24, or about 1.3 and about 12, or about 1.8 and about 4. In one embodiment, the ratio of the distance between micro-perforations in the regions of broad spacing to the distance between micro-perforations in the regions of close spacing is about 2.

In some embodiments, the thickness of the glass panel is between about 0.5 mm and about 1 mm, about 0.5 mm and about 1.5 mm, about 0.5 mm and about 2 mm, about 0.5 mm and about 2.5 mm, about 0.5 mm and about 3 mm, about 0.5 and about 3.5 mm, about 0.5 and about 4 mm, about 1 mm and about 2 mm, about 1 mm and about 2.5 mm, about 1 and about 3 mm, about 1 and about 3.5 mm, about 1 mm and about 4 mm, about 2 mm and about 3 mm, about 2 mm and about 3.5 mm, about 2 mm and about 4 mm, about 2.5 mm and about 3 mm, about 2.5 mm and about 3.5 mm about 2.5 mm and about 4 mm, about 3 mm and about 4 mm. In some embodiments, the thickness may be about 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, or any range having any two of these values as endpoints. In some embodiments the thickness of the glass panel is between about 0.5 mm and about 4 mm, or between about 0.7 mm and about 1.2 mm.

In some embodiments the diameter of the micro-perforations is about 50 um to about 100 um, about 50 um to about 200 um, about 50 um to about 300 um, about 50 um to about 400 um, about 50 um to about 500 um, about 50 um to about 600 um about 50 um to about 700 um, about 100 um to about 200 um, about 100 um to about 300 um, about 100 um to about 400 um, about 100 um to about 500 um, about 100 um to about 600 um, about 100 um to about 700 um, about 200 um to about 300 um, about 200 um to about 400 um, about 200 um to about 500 um, about 200 um to about 600 um, about 200 um to about 700 um, about 300 um to about 400 um, about 300 um to about 500 um, about 300 um to about 600 um, about 300 um to about 700 um, about 400 um to about 500 um, about 400 um to about 600 um, about 400 um to about 700 um, about 500 um to about 600 um, about 600 um to about 700 um, about 600 um to about 700 um. In some embodiments, the diameter of the micro-perforations may be about 50 um, 100 um, 150 um, 200 um, 250 um, 300 um, 350 um, 400 um, 450 um, 500 um, 550 um, 600 um, 650 um, 700 um, or any range having any two of these values as endpoints. In some embodiments, the diameter of the micro-perforations is between about 50 um and about 700 um, or between about 200 um to about 500 um.

In some embodiments, the micro-perforations are distributed with non-uniform density.

In some embodiments, the porosity of micro-perforations in the glass or glass ceramic panel is in the range of 0.05% and up to 10%. “Porosity” is the area of the micro-perforations divided by the surface area of a surface of the glass or glass ceramic panel (including the porosity area) in which the micro-perforations are formed. Where the pores have a non-uniform cross section, the area at the surface of the glass or glass ceramic panel is used to calculate porosity. Where a pore is present, the porosity will be greater than zero, but may be quite low. In some embodiments, the porosity may be 0.05%, 0.1%, 0.2%, 0.5%, 1%, 2%, 3%, 4%, 5%, 6%, 7%, 8%, 9%, 10%, or any range having any two of these values as endpoints. Porosity values outside the range 0.05%-10% may be used in some situations.

In some embodiments the micro-perforations can be in a grid-like configuration, e.g. based on squares and perpendicular lines, as shown in FIGS. 1A-B. In alternative embodiments, the micro-perforations can be in alternative structures that have regions of close spacing between micro-perforations and regions of broad spacing between micro-perforations. This could be achieved through micro-perforations in other geometric configurations that maintain regions of close spacing between micro-perforations and regions of broad spacing between micro-perforations, e.g. circles, diamonds, rectangles, etc. It could also be achieved through irregular and/or random configurations that maintain regions of close spacing between micro-perforations and regions of broad spacing between micro-perforations.

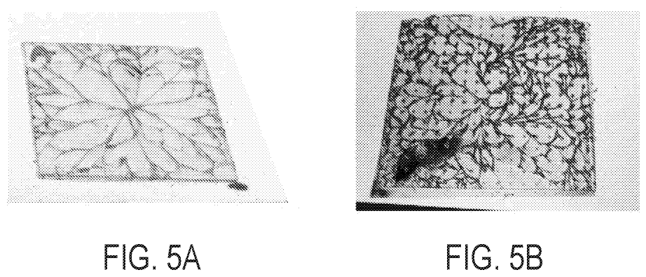

Without wishing to be bound by theory, Applicants previously determined that micro-perforations in glass and glass ceramic panels produce desirable acoustic properties for architectural uses. This is discussed in Applicant's co-owned WO 2018/085249A1 and WO 2018/200760A1, the contents of which are incorporated herein in their entirety. However, Applicants determined that glass and glass ceramic panels without micro-perforations provide more desirable safe breaking characteristics. Specifically, Applicants noted that the micro-perforations change the frangible breaking pattern of the glass or glass ceramic panel without micro-perforations (as shown in FIG. 5A) by driving the cracks toward the corners of the holes where there is higher stress which causes termination at the micro-perforations and incomplete breaking. Applicants determined that areas of closer spacing between micro-perforations produced acoustically beneficial properties in glass and glass ceramic panels. Applicants also determined that areas of broader spacing between micro-perforations produce beneficial properties related to safe breaking and meeting ANSI Z97.1 standards in glass and glass ceramic panels. Applicants additionally determined that a mixed pitch pattern of micro-perforations incorporating both closely spaced and broadly spaced micro-perforations produced desirable results in terms of both acoustics and safe breaking.

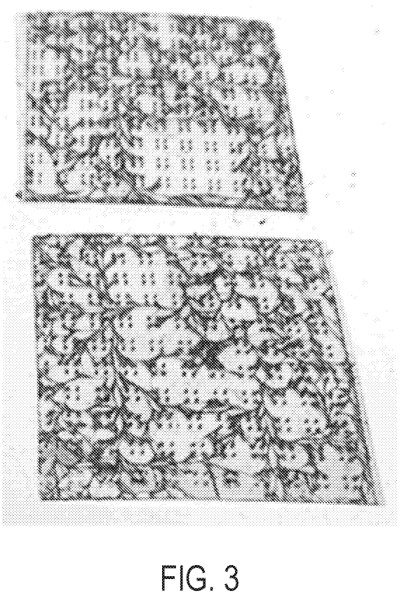

For example, FIG. 3 shows glass panels with a mixed pitch pattern of micro-perforations incorporating both closely spaced and broadly spaced micro-perforations according to an embodiment of the present invention after hole punch impact testing. The glass panels in FIG. 3 show cracks that propagate in such a manner as to create small pieces of broken glass, rather than larger more dangerous pieces. Specifically, FIG. 3 shows glass panels with a mixed pitch pattern of micro-perforations incorporating both closely spaced and broadly spaced micro-perforations that meet safe breaking requirements outlined in ANSI Z97.1 including that the total of the 10 largest crack-free pieces weighs no more than the weight of 10 square inches of the original test sample and no piece exceeds 4 inches. FIG. 5A shows a breaking pattern for a bare ion-exchanged glass without micro-perforations. FIG. 3 shows similar desirable small pieces of broken glass as the ion-exchanged bare glass that does not have micro-perforations. This result for the glass in FIG. 3 is due at least in part to the mixed pitch pattern of micro-perforations incorporated both closely spaced and broadly spaced micro-perforations according to an embodiment of the present invention.

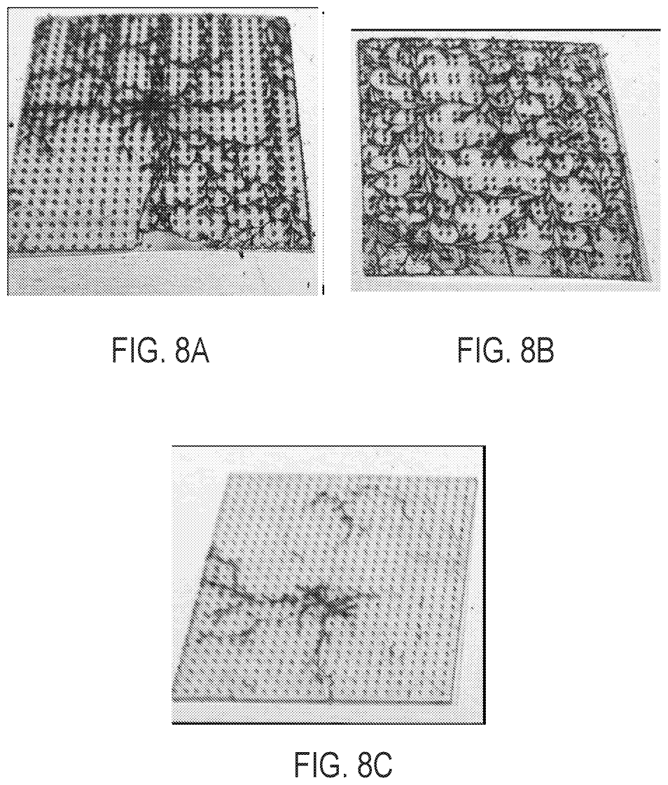

FIG. 5B shows a breaking pattern for an ion-exchanged glass with uniform spacing between micro-perforations. FIG. 5B obtains desirable breaking into small pieces due in part to an extended ion exchange time. This can be seen in FIG. 8A-C. FIG. 8A shows a glass panel with 2 mm uniform spacing that was ion exchanged for 8 hours. FIG. 8 B shows a glass panel with mixed pitch spacing, 1.5 mm for close spacing and 3.0 mm for broad spacing, that was ion exchanged for 8 hours. FIG. 8C shows a glass panel with 2 mm uniform spacing that was ion exchanged for 6 hours. FIGS. 8A and C show the undesirable larger more dangerous pieces of glass upon impact testing FIG. 8C shows the smaller glass pieces upon impact testing in accordance with an embodiment of the present invention. This shows a benefit of the present technology, namely that it allows for shorter ion exchange times with better safe breaking results.

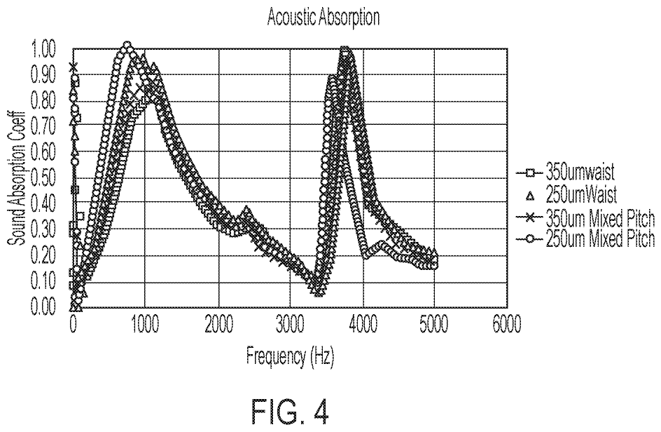

As another example, FIG. 4 shows sound absorption coefficient across various frequencies of glass panels with a mixed pitch pattern of micro-perforations incorporating both closely spaced and broadly spaced micro-perforations as compared to glass panels with micro-perforations with uniform spacing that do not incorporate the mixed pitch. FIG. 4 shows that the glass panels with a mixed pitch pattern of micro-perforations incorporating both closely spaced and broadly spaced micro-perforations performed similar or better than glass panels with micro-perforations with uniform spacing that do not incorporate the mixed pitch as is also shown in Table 2 below.

TABLE 2
Sample micro-perforation waist size and type of spacing between micro-
perforations and noise reduction coefficient (NRC) performance

| Sample | NRC |
|---|---|
| 350 um waist with uniform spacing | 0.4 |
| 350 um waist with mixed pitch spacing | 0.45 |
| ~1.5 mm close spacing | |
| ~3 mm broad spacing | |
| Square grid | |
| 250 um waist with uniform spacing | 0.53 |
| 250 um waist with mixed pitch spacing | 0.57 |
| ~1.5 mm close spacing | |
| ~3 mm broad spacing | |
| Square grid | |

An NRC value of 1 is the highest value and those greater than approximately 0.3 are desirable for architectural applications, preferably greater than approximately 0.4.

In some embodiments, the panel is configured to decrease reverberation time of an operative environment. As used herein, “operative environment” may include an enclosed or semi-enclosed environment that requires a certain acoustic environment. For example, conference rooms, offices, schools, hospitals, manufacturing facilities, clean rooms (food, pharmaceutical), museums, historical buildings, restaurants, etc., may all be “operative environments”. In some embodiments, the panel is integrated in a lighting solution, for example, a lighting fixture in a ceiling or a wall. In this regard, the transparent nature of the panel is used to allow for light, while taking advantage of the noise reduction properties of the panel. Natural air spacing behind the panel (in the lighting fixture) may also be advantageous from a noise reduction perspective.

In some embodiments, the panel includes a strengthened glass or glass ceramic. The use of glass or glass ceramic materials allows for favorable properties, including any one of or a combination of providing a transparent, translucent or opaque appearance, providing durability, providing resistance to corrosion, providing design flexibility, and providing flame resistance.

In some embodiments, for a strengthened glass, the surface compression is balanced by a tensile stress region in the interior of the glass. Surface compressive stress (“CS”) greater than 400 MPa, greater than 500 MPa, greater than 600 MPa, greater than 700 MPa, or greater than 750 MPa and compressive stress layer depths (also called depth of compression, or “DOC”) greater than 40 microns are readily achieved in some glasses, for example, alkali aluminosilicate glasses, by chemically strengthening processes (e.g., by ion exchange processes). DOC represents the depth at which the stress changes from compressive to tensile.

In some embodiments, the panel includes a non-strengthened glass, for example, a soda-lime glass. In some embodiments, the panel includes strengthened glass or glass ceramic that is mechanically, thermally or chemically strengthened. In some embodiments, the strengthened glass or glass ceramic may be mechanically and thermally strengthened, mechanically and chemically strengthened or thermally and chemically strengthened. A mechanically-strengthened glass or glass ceramic may include a compressive stress layer (and corresponding tensile stress region) generated by a mismatch of the coefficient of thermal expansion between portions of the glass or glass ceramic. A chemically-strengthened glass or glass ceramic may include a compressive stress layer (and corresponding tensile stress region generated by an ion exchange process). In such chemically strengthened glass and glass ceramics, the replacement of smaller ions by larger ions at a temperature below that at which the glass network can relax produces a distribution of ions across the surface of the glass that results in a stress profile. The larger volume of the incoming ion produces a CS on the surface portion of the substrate and tension in the center of the glass or glass ceramic. In thermally-strengthened glass or glass ceramics, the CS region is formed by heating the glass or glass ceramic to an elevated temperature above the glass transition temperature, near the glass softening point, and then cooling the surface regions more rapidly than the inner regions of the glass or glass ceramic. The differential cooling rates between the surface regions and the inner regions generates a residual surface CS, which in turn generates a corresponding tensile stress in the center region. In one or more embodiments, the glass substrates exclude annealed or heat strengthened soda lime glass. In one or more embodiments, the glass substrates include annealed or heat strengthened soda lime glass

Applicants also unexpectedly determined that the time required to chemically strengthen glass panels with a mixed pitch pattern of micro-perforations incorporating both closely spaced and broadly spaced micro-perforations (e.g., ˜1.5 mm for close spacing and ˜3.0 mm for broad spacing) is lower than the time required to chemically strengthen glass panels with micro-perforations with uniform spacing that do not incorporate the mixed pitch (e.g., 2.0 mm spacing). In one specific example, the time required to chemically strength glass panels with a mixed pitch pattern of micro-perforations incorporating both closely spaced and broadly spaced micro-perforations with ˜1.5 mm for close spacing and ˜3.0 mm for broad spacing took approximately 6 hours. In one specific comparative example, the time required to chemically strengthen glass panels with micro-perforations with uniform spacing that do not incorporate the mixed pitch with 2.0 mm spacing took approximately 10 hours. Hence by using this mixed pitch spacing, it is possible to not only achieve the acoustic benefits, safe breaking benefits and also lower the chemical strengthening time. This in turn would also reduce the process cost associated with chemical strengthening.

In some embodiments, the glass or glass ceramic may have surface compressive stress of between about 100 MPa and about 1000 MPa, between about 100 MPa and about 800 MPa, between about 100 MPa and about 500 MPa, between about 100 MPa and about 300 MPa, or between about 100 MPa and about 150 MPa. In some embodiments, the DOC may be between 0.05*t and about 0.21*t (where t is thickness of the glass or glass ceramic in micrometers). In some embodiments, DOC may be in the range from about 0.05*t to about 0.2*t, from about 0.05*t to about 0.18*t, from about 0.05*t to about 0.16*t, from about 0.05*t to about 0.15% from about 0.05*t to about 0.12*t, from about 0.05*t to about 0.1*t, from about 0.075*t to about 0.21*t, from about 0.1*t to about 0.21*t, from about 0.12*t to about 0.21*t, from about 0.15*t to about 0.21*t, from about 0.18*t to about 0.21*t, or from about 0.1*t to about 0.18*t.

In some embodiments, the panel has an NRC of between about 0.3 and 1, or between about 0.3 and 0.8. In some embodiments, the panel has a predetermined sound absorption coefficient over a predetermined frequency band between 250 Hz and 6000 Hz, or between 250 Hz and 20,000 Hz. In some embodiments, the panel may be “tuned” to absorb particular frequencies of interest, for example, in a machinery room or for a HVAC application. In some embodiments, the panel has an NRC of 0.3, 0.4, 0.5, 0.6, 0.7, 0.8, 0.9, 1.0, or any range having any two of these values as endpoints.

In some embodiments, the panel of present disclosure includes a coating, such as a photochromic, thermal control, electro-chromic, low emissivity, UV coatings, anti-glare, hydrophilic, hydrophobic, anti-smudge, anti-fingerprint, anti-scratch, anti-reflective, ink jet decorated, screen-printed, anti-splinter, etc. In some embodiments, the micro-perforations are not blocked by the coating. In some embodiments, the interior of the micro-perforations are not coated. In some embodiments, a portion of the micro-perforations are blocked by the coating. In some embodiments, the panel includes an anti-microbial component.

In some embodiments, the panel of present disclosure may be of uniform thickness, or non-uniform thickness. In some embodiments, the panel may be substantially planar. In some embodiments, the panel may be curved, for example, or have a complex shape. In some embodiments, the panel may be a shape, for example, rectangular, round, etc. In some embodiments, the panel may be flexible. In some embodiments, the panel may be substantially rigid. In some embodiments, the geometric attributes of the panel (e.g., micro-perforation diameter, micro-perforation shape, pitch, panel thickness, etc.) and the absorption coefficient of the panel may be tuned to achieve desired room acoustics.

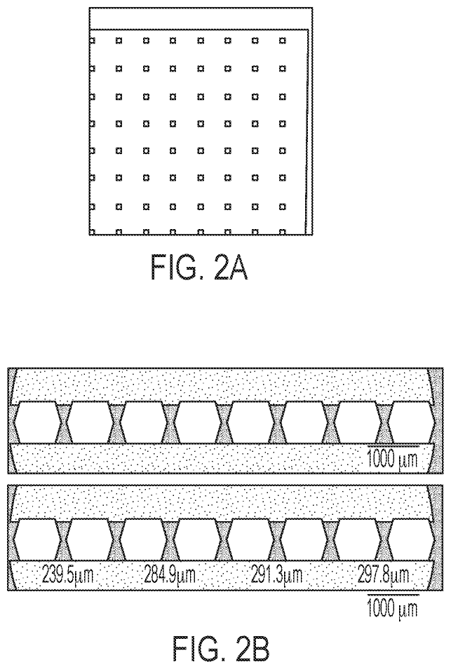

As shown in 2B, the cross section of the micro-perforations may vary along a length of the micro-perforation through the panel. For example, FIG. 2B shows an hourglass-shaped cross section (or “bottle neck” shaped). In another example, the cross section of the micro-perforations can be generally cylindrical. In some embodiments, the micro-perforations may be along a constant axis generally normal to a surface of the panel, or may be along a varied axis, or may be positioned not normal to a general surface of the panel.

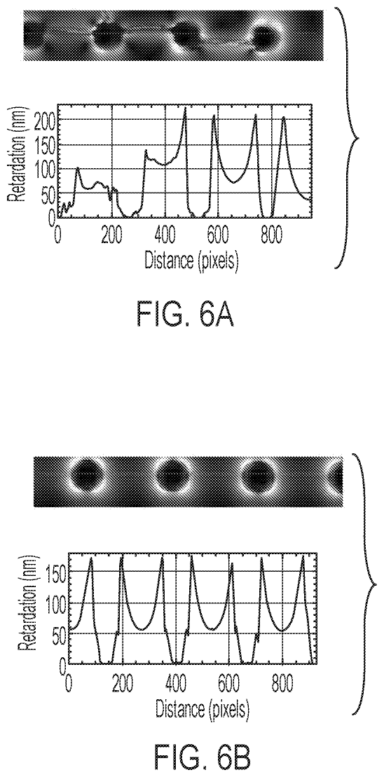

In some embodiments, the micro-perforations have a generally circular cross-section through the thickness of the panel. In some embodiments, the micro-perforations have a non-circular cross-section through the thickness of the panel. For example, Applicants determined that the surface micro-perforation profile can be modified to further increase the stress concentration around the micro-perforations in order to favor the crack to propagate towards the region with higher stress concentration and help with crack arresting/termination. FIG. 6 demonstrates that the micro-perforations that are uneven and/or have high circularity (FIG. 6A) will have higher stress concentration (proportional to retardation) than holes with an even shape (FIG. 6B). Without wishing to be bound by theory, the stress is higher around the holes than between the holes. The photoelastic stress retardation was measured using a polariscope. The surface micro-perforation profile can be modified to have various shapes, e.g. shapes with angles such as those shown in FIG. 7, to increase the stress concentration to direct the crack towards the high stress concentration micro-perforations and arrest them. The shape of the holes can be intentionally designed to increase the roughness around the edges and thereby increase the stress concentration which will attract the crack towards the high stress region and arrest it. In some embodiments, the shape of the micro-perforation through a cross-section of a panel varies, or is substantially constant.

In some embodiments, the articles of present disclosure may include multiple panels (e.g., double leaf or multi-leaf configurations). For example, in some embodiments, an article includes a first and second glass or glass ceramic panels, each having a plurality of micro-perforations positioned at non-uniform intervals along the panel wherein the panels each have regions of close spacing between micro-perforations and regions of broad spacing between micro-perforations. In some embodiments, the first and second panels are generally parallel to each other. In some embodiments, the panels may be spaced with a varying distance from one another, for example, non-parallel spacing, or through variation in dimensions of the panels themselves. In some embodiments, at least a portion of an edge of at least one of the panels is sealed to a holding portion. In some embodiments, one or more panels may have a sealed edge, or none may be sealed. In some embodiments, additional panels may be used, for example with uniform dimensions or varying dimensions. In some embodiments, the multiple panels may be uniformly spaced from one another, or have varying spacing. In one or more embodiments, the first and second glass or glass ceramic panels have the same thickness or a thickness that differ from one another.

In some embodiments, the intra-panel gap distance may be varied according to acoustic requirements and part of the overall design to absorb specific frequencies. In some embodiments, the intra-panel gap may be varied according to the aspect ratio, micro-perforation size, pitch, panel thickness, and the frequency range of interest, for example. In some embodiments, additional panels may be included, with multiple intra-panel gaps such that the system broadens the absorption spectra (in frequency), for example, or increases the absorption magnitude.

Some embodiments of present disclosure are directed to a method of forming micro-perforations in a glass or glass ceramic panel, including: (i) forming a plurality of damage tracks into the glass or glass ceramic panel by a laser beam, wherein the damage tracks are positioned at non-uniform intervals with regions of close spacing between damage tracks and regions of broad spacing between damage tracks; and (ii) etching the panel obtained from (i) in an acid solution to form a micro-perforated panel with micro-perforations at non-uniform intervals along the panel having regions of close spacing between micro-perforations and regions of broad spacing between micro-perforations, wherein the NRC of the micro-perforated panel is between about 0.3 and 1, or between about 0.3 and 0.8.

In some embodiments, the laser beam is a pulsed laser beam having a focal line oriented along a beam propagation direction and directing the laser beam focal line into the panel. In some embodiments, the method further includes, etching the glass panel in a second acid solution that is different from the first acid solution. In some embodiments, the method further includes, chemically or thermally strengthening the micro-perforated panel. In some embodiments, the glass or glass ceramic panel comprises a high-strength glass or glass ceramic composition. In some embodiments, the thickness of the glass or glass ceramic panel is between about 0.5 mm and 4 mm. Applicant's co-owned WO 2018/085249 includes further discussion of methods of making acoustic glass and glass ceramics with micro-perforations and is incorporated herein in its entirety.

In one example, the micro-perforations in the glass are made by scribing an array of laser damage tracks across the thickness of the glass. This method creates a single damage track through the thickness of the glass part. It uses a short pulse, e.g. ˜10 psec, laser with line focus optics to create long laser damage tracks. These tracks have a very small diameter, generally between 0.25 to 1 um. Each laser pulse creates a track that extends across the thickness of the glass. The pattern of the damage tracks, e.g. squares, allows for a method of fabrication in which the stages on the laser tool continuously move at high speed in a specific direction and the laser opens only at pre-defined locations. This happens without deacelaration or stopping the staged movement. For this design, the laser is programmed to create a damage track at close and broadly spaced intervals, e.g. 1.5 mm & 3 mm or the other distances discussed above. The region of glass within the as formed squares will drop when etched creating a thru hole in the glass.

Samples can then be preheated and immersed into a molten bath of 100% Technical grade Potassium Nitrate salt with 0.5% silicic acid. Samples remain in the bath for an allotted time. They can then be removed to drip dry and slowly cool. Once cool, the samples can be immersed or rinsed in tap water to remove excess salt crystals. Finally, the samples are rinsed with deionized water and then air dried. Alternately, other mixed salt baths can be employed at different percentages.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. An article, comprising:
a glass or glass ceramic panel having a plurality of micro-perforations positioned at non-uniform intervals along the panel
wherein the panel has regions of close spacing between micro-perforations and regions of broad spacing between micro-perforations.

2. The article of claim 1, wherein the regions of close spacing have a distance between micro-perforations of between about 0.25 mm and about 5 mm, or between about 1 mm and about 2 mm.

3. The article of claim 1, wherein the regions of broad spacing have a distance between micro-perforations of between about 0.5 mm and about 6 mm, or between about 2 mm and about 4 mm.

4. The article of claim 1, wherein the ratio of the distance between micro-perforations in the regions of broad spacing to the distance between micro-perforations in the regions of close spacing is between about 1.3 and about 12, or between about 1.8 and about 4.

5. The article of claim 1, wherein the thickness is between about 0.5 mm and about 4 mm, or between about 0.7 mm and about 1.2 mm.

6. The article of claim 1, wherein the panel comprises a strengthened glass or glass ceramic.

7. The article of claim 6, wherein the strengthened glass or glass ceramic is mechanically, thermally or chemically strengthened.

8. The article of claim 1, wherein the panel has a Noise Reduction Coefficient (NRC) of between about 0.3 and 1, or between about 0.3 and about 0.8.

9. The article of claim 1, wherein the panel having a predetermined sound absorption coefficient over a predetermined frequency band between 250 Hz and 6000 Hz, or between 250 Hz and 20,000 Hz.

10. The article of claim 1, wherein the panel breaks upon hole punch impact to produce crack-free pieces and wherein the weight of the ten largest crack-free pieces is less than or equal to the weight of 10 square inches of the original panel.

11. The article of claim 1, wherein the micro-perforations are distributed with non-uniform density along the panel.

12. The article of claim 1, wherein an opening of a plurality of the micro-perforations are non-circular.

13. The article of claim 1, wherein the porosity of micro-perforations is in the range of about 1% to 10%.

14. The article of claim 1, wherein the diameter of each of the plurality of micro-perforations is between about 20 um and about 700 um, or between about 200 um and about 500 um.

15. An article, comprising:
first and second glass or glass ceramic panels each having a plurality of micro-perforations positioned at non-uniform intervals along the panel
wherein the panels each have regions of close spacing between micro-perforations and regions of broad spacing between micro-perforations.

16. The article of claim 15, wherein the first and second panels are spaced from each other by an intra-panel gap that defines a separation distance.

17. The article of claim 15, wherein the first and second panels are generally parallel to each other.

18. The article of claim 15, wherein the article is thermally strengthened.

19. The article of claim 15, wherein the first and second panels are positioned such that there is no solid back wall within 1 m of the first and second panels that is generally parallel to the first panel or the second panel.

20. The article of claim 15, wherein the first and second panels are positioned such that there is a solid back wall within 1 m of the first and second panels that is generally parallel to the first panel or the second panel.

21. The article of claim 15, wherein the NRC of the article is 0.4 or greater.

22. The article of claim 15, wherein the porosity of micro-perforations in each of the first and second glass or glass ceramic panels is in the range of about 1% to about 10%.

23. The article of claim 15, wherein the diameter of each of the plurality of micro-perforations is in the range of about 50 um to about 700 um, or about 200 um to about 500 um.
